(19) United States
(12) Patent Application Publication
(10) Pub. No.: US 2010/0051305 A1
(43) Pub. Date: Mar. 4, 2010

(54) Drive

(75) Inventor: Philip Bunce, Victoria (AU)

Correspondence Address: MERCHANT & GOULD PC, P.O. BOX 2903, MINNEAPOLIS, MN, 55402-0903, US

(73) Assignee: EASTLAND MEDICAL SYSTEMS LTD., West Perth, Western Australia (AU)

(21) Appl. No.: 11/547,176

(22) PCT Filed: Mar. 24, 2005
(86) PCT No.: PCT/AU05/00429

§ 371 Date: Aug. 8, 2009

(30) Foreign Application Priority Data
Mar. 31, 2004 (AU) 2004901717

(51) Int. Cl. F16H 21/12

(52) U.S. Cl. 173/214; 74/63

(57) ABSTRACT

A drive enabling relative movement between two members, said one member being supported from the other member for relative movement parallel to a first axis or concentrically about said first axis, a drive member received between the members and being capable of movement relative to said members along a second axis which is transverse to the path of said relative movement between the members, the drive member being movable with the one member along the path of said relative movement, the drive member cooperating with the other member whereby with movement of the drive member along the second axis the members are subjected to said relative movement.

### FIELD OF THE INVENTION

This invention relates to a drive.

### BACKGROUND

The invention relates to a drive which is able to effect a controlled movement between two elements.

A particular application of the drive of the invention relates to a drive which can be utilized in the machining of needles utilizing a rotary jig of the form disclosed in application PCT/AU2004/000090. In machining of needles which are utilized in hypodermic syringes the rotary jig of the abovementioned application is mounted to a drive head which is capable of causing rotation of the jig about its central axis and which is also capable of causing relative rotation movement between inner and outer clamping surfaces provided by the jig. Because of the dimensions of the needles the degree of rotational movement between the clamping surfaces is very limited and needs to be very accurately controlled with minimal or no lash.

In addition there are other circumstances which arise in which an item supported from a base supporting structure where the item needs to be capable of general but when at a particular position must also be capable of accurate controlled movement. A particular application of this arrangement relates to mounting of a telescope where it becomes necessary to cause the telescope to move about an axis in order that the telescope can be directed and track a celestial object but there must also be very controlled calibrated movement of the telescope upon the support structure in order to accurately position the telescope. A similar arrangement relates to tracking arrangements used for targeting of weaponry such as missiles at a target.

### DISCLOSURE OF THE INVENTION

Accordingly the invention resides in a drive enabling relative movement between two members, said one member being supported from the other member for relative movement parallel to a first axis or concentrically about said first axis, a drive member received between the members and being capable of movement relative to said members along a second axis which is transverse to the path of said relative movement between the members, the drive member being movable with the one member along the path of said relative movement, the drive member cooperating with the other member whereby with movement of the drive member along the second axis the members are subjected to said relative movement.

According to a preferred feature of the invention the drive member is elongate, the central axis of the drive member being parallel to a third axis which is angularly offset from the second axis, the drive member being received in a passage in the other member. According to a preferred feature the passage is provided by an element which is pivotally supported from the other member. According to a preferred feature of the invention the drive comprises a plurality of drive members.

According to a preferred feature of the invention the opposed faces of the drive member and the other member are formed with a pair of opposed grooves which can cooperate when aligned to define an elongate passage of circular cross-section, said the central axis of the passage being parallel to a third axis which is angularly offset from the second axis, the passage supporting a ball member conforming to the cross-sectional dimensions of the passage

According to a further aspect of the invention the invention resides in drive enabling relative movement between two members, said one member being supported from the other member for relative movement parallel to a first axis or concentrically about said first axis, a drive member received between the members and being capable of movement relative to both members along a second axis which is transverse to the path of said relative movement between the members, the drive member engaged with the one member to be moved along the path of said relative movement with the one member, the abutting faces of the drive member and the other member of the drive member and the other member are formed with a pair of opposed grooves which can cooperate when aligned to define an elongate passage of circular cross-section, the central axis of the passage being parallel to the third axis angularly offset from the second axis, the passage supporting a ball member conforming to the cross-sectional dimensions of the passage.

According to a further aspect of the invention the invention resides in drive enabling relative movement between two members, said one member being supported from the other member for relative movement parallel to a first axis or concentrically about said first axis, a drive member received between the members and being capable of movement relative to both members along a second axis which is transverse to the path of said relative movement between the members, the drive member engaged with the one member to be moved along the path of said relative movement with the one member, the drive member being elongate and having a central axis angularly offset from the second axis, and the other member having a passage which slidably receives the drive member.

According to a preferred feature of all aspects of the invention the path of said relative movement between the members is circular and is centred about the first axis.

According to a preferred feature of the invention the second axis is substantially perpendicular to the path of relative movement.

According to a preferred feature of the invention the drive comprises a part of a work head of a machining centre wherein the drive is intended support a jig having two portions which are in use to be associated with the members whereby the portions will be caused to be subjected to said relative movement on said relative movement between the members, said drive being intended to be cause to rotate about the first axis, said jig being intended to support a plurality of workpieces at angularly displaced locations around the jig, said workpieces being supported from the jig to be caused to rotate about their central axes with said relative movement of the members.

According to a preferred feature of the invention the workpieces are elongate and the portions are provided with concentric opposed face which are intended to receive the workpieces between them wherein the central axes of the workpieces are substantially parallel with the first axis and relative movement between the portions causes the workpieces to rotate about their central axes.

According to a preferred feature of the invention one of the portions comprises a set of shoes which are removably supported from the jig, each shoe when supported from the jig being movable axially relative to the other portion into and out of clamping engagement with the other portion, the shoes each being adapted to support the workpieces.

The invention will be more fully understood in the light of the following description of several specific embodiments.

### BRIEF DESCRIPTION OF THE DRAWINGS

The description is made with reference to the accompanying drawings of which:

FIG. 1 is an isometric view of a drive according to the first embodiment;

FIG. 2 is an exploded view of a drive according to the first embodiment;

FIG. 3 is a part sectional view of the bearing arrangement between the drive member and the other member according to the first embodiment;

FIG. 4 is a sectional view of a drive according to the first embodiment;

FIG. 5 is an exploded view of a drive according to the second embodiment;

FIG. 6 is an exploded view of a drive according to the third embodiment.

### DETAILED DESCRIPTION OF SPECIFIC EMBODIMENTS

Each of the embodiments are directed to a drive which can be utilized in association with a rotary jig of the form disclosed as the first embodiment of the invention of international application PCT/AU2004/000090 the disclosure of which is incorporated hereto by reference. Each of the embodiments provide a drive whereby the outer portion of the jig is caused to rotate about a central axis and the central portion of the jig together with the shoes which support the needle blanks is capable of relative rotation about the same central axis relative to the outer portion as well as rotation with the outer portion about the central axis. This controlled movement of the central portion relative to the outer portion must be effected accurately and without any lash and relates to a very small degree of movement which is required to effect the desired rotation of the needle blanks supported between the central and outer portions.

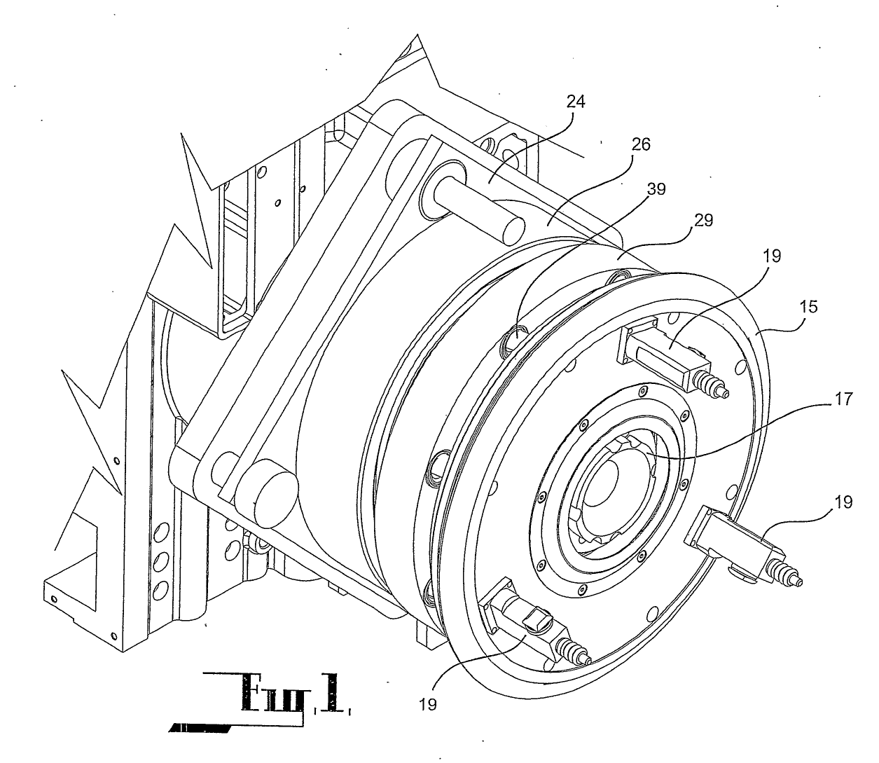

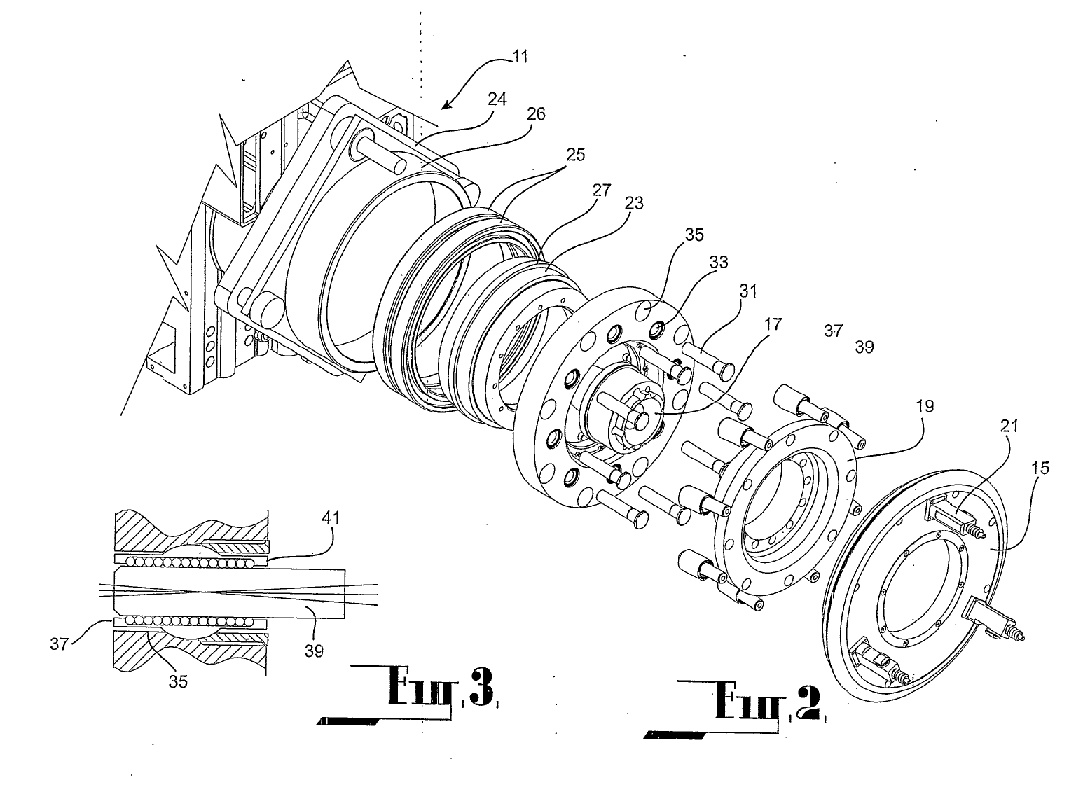

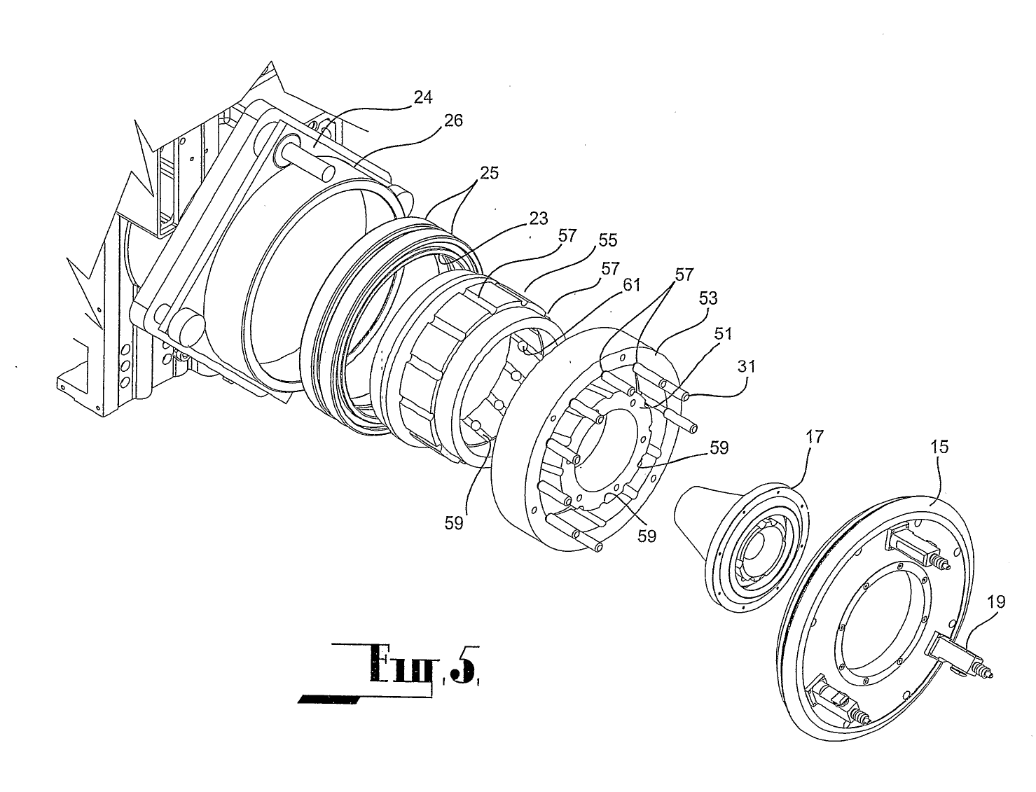

The first embodiment as shown at FIGS. 1, 2, 3 and 4 comprises a drive which comprises a drive head 11 having a drive shaft 13 connected to a suitable drive to effect rotation of the drive shaft 13 about its outer most axis. The drive head 11 is provided with a chuck 17 supported from one end of a drive shaft 13 for rotation with the drive shaft. The chuck 17 is provided with a hub 19 which extends radially from the chuck 17. The drive head further comprises a supports a support plate 15 a the support plate 15 which is rotatably supported from the hub 19 for rotation about a central axis of the chuck 17.

The support plate is provided with a set of axially directed equiangular spaced pegs 21 which are to support the jig (not shown). In use the jig is supported from the drive head by being engaged with both the chuck 17 and the pegs 21 of the support plate 15 whereby the shoes and their support are supported from the pegs 21 while the outer portion of the jig which provides the outer clamping surface is supported from the chuck 17.

The drive shaft is associated with a drive assembly which rotates with the drive shaft 17 and which includes an annular bearing block 23 which is supported to be slidable axially upon the drive shaft towards and away from the hub 19. The bearing block is associated with a back plate 24 which is fixed rotationally with respect to a drive shaft and which is further moveable axially with the bearing block 23. The back plate connected to the bearing block 23 through a pair of axially spaced thrust bearings 25 received between the bearing block and a skirt supported on the back plate. The outer radial face of the bearing block 23 is formed with a central rib 27 which is received between the thrust bearings 25. The back plate 24 is associated with an extension means such as a fluid operated cylinder or like mechanical means which is supported from the drive head 11 whereby extension and retraction of the extension means (instead of hydraulic cylinder) causes axial movement of the back plate 24 and thus the bearing block 23 on the drive shaft.

The drive further comprises a bearing plate 29 which is rotatable with the drive shaft and is supported from the bearing block 23 to be moveable axially with the bearing block 23. The bearing plate is connected to the hub 19 through a set of first rods 31 which are supported at one end from the hub 19 and are receivable through linear bearings 33 in the bearing plate 29. The central axes of the linear bearings are parallel to the central axis. As a result of axial movement of the bearing block 23, the bearing plate 29 is caused to move axially and will slide along the first rods 31. As a result the hub 19 will rotate with the drive shaft.

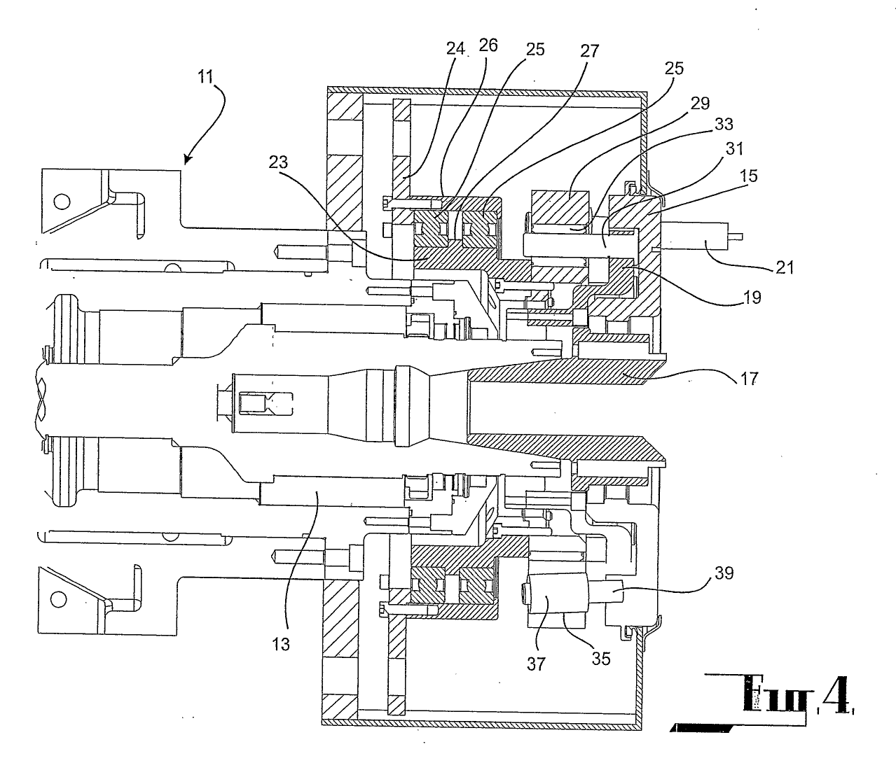

In addition the bearing plate 29 is provided with a set of bores 35 the central axes of which angularly offset from the central axis of the chuck 17 and which accommodate linear bearings 37 (see FIG. 3). In addition the support plate 15 supports a set of second rods 39 where the angular orientation of the central axes of the second rods correspond with the angular orientation of the bores 35 The second rods are slidably are received in the linear bearings 37 which each comprise a tubular member 41 which is pivotally supported in the bores 35 to accommodate for the relative displacement between the rods 39 and the central axis of the respective bore 35 with axial displacement of the bearing plate 29 relative to the support plate 15.

With axial movement of the bearing plate 25 relative to the support plate 15 there will be controlled relative rotational movement of the support plate with respect to the bearing plate 29 and thus to the hub 19. The degree of relative rotation between the support plate 15 and the hub 19 is controlled due to the close alignment of the second rods 39 within the linear bearings 37 and is limited. As a result the relative movement between the portions of the jig are closely and accurately controlled. This is required for the adequate machining of needle blanks.

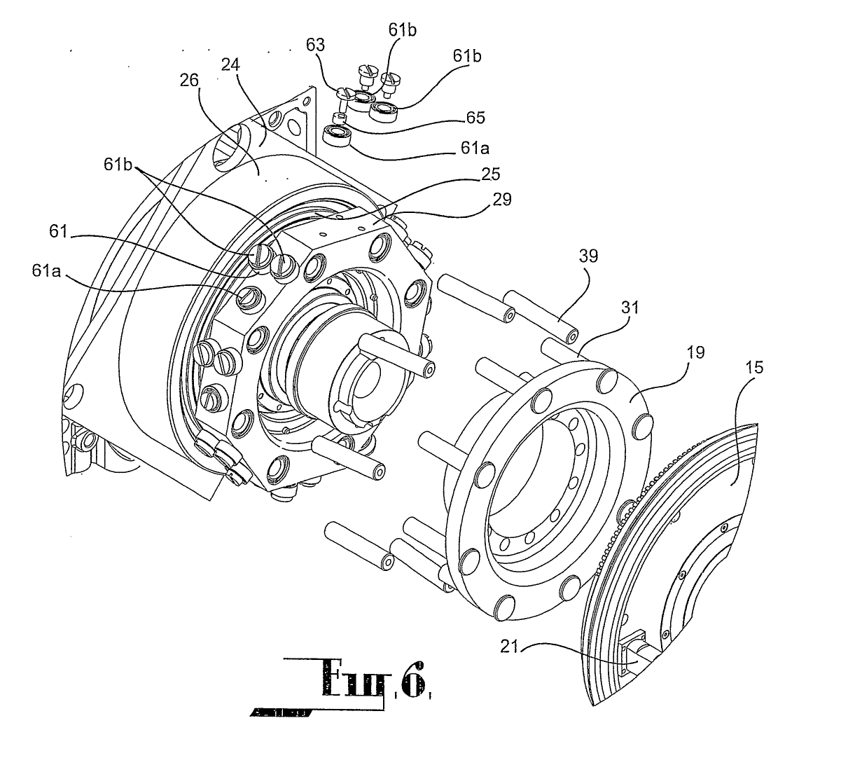

In the case of the second embodiment as shown at FIG. 5 the components corresponding with components of the first embodiment have been given the same reference numerals. In the case of the second embodiment the bearing plate 29 of the first embodiment is replaced by an inner ring 51 and an outer ring 53 which are concentrically supported upon the drive shaft assembly with an intermediate ring 55 located therebetween. The inner ring 51 rotates with the drive shaft and the bearing block 23 bears on the innermost axial face of the intermediate ring 55 whereby the intermediate ring 55 is slidably axially relative to the inner and outer rings 51 and 53. The opposed radial faces of the outer ring 53 and intermediate ring 55 are provided with a set of elongate grooves which are parallel to the central axis of the drive shaft and which are associated with a set of first rods 31, which are slidably received through the first set of grooves 57 provided on the opposed faces of the outer and intermediate ring 53 and 55. Therefore as a result of axial movement of the bearing block 23 the intermediate ring 55 is displaced axially and moves axially through the outer ring 53 without causing any rotational displacement of the support plate 15 relative to the drive shaft.

The opposed radial faces of the inner ring 51 and an intermediate ring 55 are also provided with a set of second grooves 59 which when aligned form a passage of circular cross section therebetween. The central axes grooves however are displaced angularly from the axis of the grooves 57 between the outer ring 53 and the intermediate ring 55. The second grooves 59 support between themselves a single ball having a cross sectional configuration corresponding to the cross sectional configuration of the second grooves 59 when aligned. The axial displacement of the bearing block 53 causes axial displacement of the intermediate ring 55 relative to the inner ring and as a result the second grooves 59 of the inner and intermediate ring 53 and 55 move relative to each other from a position at the mid-position which they are substantially aligned and a position to either side of the mid position at which the grooves are not aligned. However, the presence of the ball 59 between the grooves requires that the ball be located at the intersection of the second grooves 59 and as a result of it being resident at that point of intersection the inner ring 51 is caused to rotate relative to the outer ring 53. Because of the very close tolerance between the ball 61 and the locus of intersection of the second grooves 59, the degree of relative movement between the inner ring 51 and the outer ring 53 is closely controlled.

In the case of the third embodiment as shown at FIG. 6 the components corresponding with components of the first and second embodiment have been given the same reference numerals. The third embodiment is a variation from the first embodiment whereby the off centre bores 35 which receive the second rods 39 and the associated linear bearings 37 are replaced by a guide provided on the outer face of the bearing plate 29. The bearing plate 29 is polygonal and the faces of the bearing plate 29 are in one-two-one correspondence with the second rods 39 which are in turn supported from the support plate 15. Each of the guides comprises a set of bearings 61 fixed to each face of the bearing plate 29 and which define between themselves a passageway having a transverse dimension corresponding to that of the second rods 39. The bearings are located such that two 61b are located to one side of the passage and one 61a is located to the other side. The one bearing 61a is supported from the face by a stud and an eccentric bush 65 whereby with rotation of the eccentric bush 65 about the stud 23 the spacing of the one bearing 61a relative to the other bearings 61b can be adjusted.

According to a second embodiment the first rods 31 of the first embodiment can be replaced by a set of balls.

Throughout the specification, unless the context requires otherwise, the word “comprise” or variations such as “comprises” or “comprising”, will be understood to imply the inclusion of a stated integer or group of integers but not the exclusion of any other integer or group of integers.

It should be appreciated that the scope of the present invention need not be limited to the particular scope of the embodiments described above.

1. A drive enabling relative movement between two members, said one member being supported from the other member for relative movement parallel to a first axis or concentrically about said first axis, comprising: a drive member received between the members and being capable of movement relative to said members along a second axis which is transverse to the path of said relative movement between the members, the drive member being movable with the one member along the path of said relative movement, the drive member cooperating with the other member whereby with movement of the drive member along the second axis the members are subjected to said relative movement.

2. A drive as claimed at claim 1 wherein the drive member is elongate, the central axis of the drive member being parallel to a third axis which is angularly offset from the second axis, the drive member being received in a passage in the other member.

3. A drive as claimed at claim 2 wherein the passage is provided by an element which is pivotally supported from the other member.

4. A drive as claimed at claim 1 wherein the drive comprises a plurality of drive members.

5. A drive as claimed at claim 1 wherein the opposed faces of the drive member and the other member are formed with a pair of opposed grooves which can cooperate when aligned to define an elongate passage of circular cross-section, said the central axis of the passage being parallel to a third axis which is angularly offset from the second axis, the passage supporting a ball member conforming to the cross-sectional dimensions of the passage.

6. A drive enabling relative movement between two members, said one member being supported from the other member for relative movement parallel to a first axis or concentrically about said first axis, comprising: a drive member received between the members and being capable of movement relative to both members along a second axis which is transverse to the path of said relative movement between the members, the drive member engaged with the one member to be moved along the path of said relative movement with the one member, the abutting faces of the drive member and the other member of the drive member and the other member are formed with a pair of opposed grooves which can cooperate when aligned to define an elongate passage of circular cross-section, the central axis of the passage being parallel to the third axis angularly offset from the second axis, the passage supporting a ball member conforming to the cross-sectional dimensions of the passage.

7. A drive enabling relative movement between two members, said one member being supported from the other member for relative movement parallel to a first axis or concentrically about said first axis, comprising: a drive member received between the members and being capable of movement relative to both members along a second axis which is transverse to the path of said relative movement between the members, the drive member engaged with the one member to be moved along the path of said relative movement with the one member, the drive member being elongate and having a central axis angularly offset from the second axis, and the other member having a passage which slidably receives the drive member.

8. A drive as claimed at claim 6 wherein the path of said relative movement between the members is circular and is centred about the first axis.

9. A drive as claimed at claim 6 wherein the second axis is substantially perpendicular to the path of relative movement.

10. A drive as claimed at claim 1 wherein the drive comprises a part of a work head of a machining centre wherein the drive is intended support a jig having two portions which are in use to be associated with the members whereby the portions will be caused to be subjected to said relative movement on said relative movement between the members, said drive being intended to be cause to rotate about the first axis, said jig being intended to support a plurality of work pieces at angularly displaced locations around the jig, said work pieces being supported from the jig to be caused to rotate about their central axes with said relative movement of the members.

11. A drive as claimed at claim 10 wherein the work pieces are elongate and the portions are provided with concentric opposed face which are intended to receive the work pieces between them wherein the central axes of the work pieces are substantially parallel with the first axis and relative movement between the portions causes the work pieces to rotate about their central axes.

12. A drive as claimed at claim 10 wherein one of the portions comprises a set of shoes which are removably supported from the jig, each shoe when supported from the jig being movable axially relative to the other portion into and out of clamping engagement with the other portion, the shoes each being adapted to support the work pieces.

13. (canceled)
